(19) United States
(12) Patent Application Publication
(10) Pub. No.: US 2022/0391829 A1
(43) Pub. Date: Dec. 8, 2022

(54) RETAIL SYSTEMS

(71) Applicant: Mallard Holdings LLC, Grand Prairie, TX (US)

(72) Inventors: Brian L. Mallard, Grand Prairie, TX (US); Lawrence D. Holt, II, Mabank, TX (US); Robert Kay, Thousand Oaks, CA (US); Guillermo J. Chavez, Frisco, TX (US); Graham Ross, Oceanside, CA (US)

(73) Assignee: Mallard Holdings LLC, Grand Prairie, TX (US)

(21) Appl. No.: 17/835,516

(22) Filed: Jun. 8, 2022

Related U.S. Application Data
(60) Provisional application No. 63/208,038, filed on Jun. 8, 2021.

(51) Int. Cl. G06Q 10/08; A47F 5/00; A47F 1/12

(52) U.S. Cl. CPC G06Q 10/087; A47F 5/0043; A47F 1/12

(57) ABSTRACT

A shelving system for replenishing a stock of a product. The shelving system uses gondolas each having a base, a support structure coupled to the base, and a shelf coupled to the support structure. The system has a first configuration that provides access to the front of the shelf but not to the back of the shelf. The system has a second configuration that provides access to the back of the shelf so as to enable replenishment of the stock by adding additional product from the back of the shelf.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

### Field

The present invention generally relates to retail stores, in particular the fixtures, layout, and customer experience of shopping in a brick-and-mortar store.

### Description of the Related Art

Many conventional stores provide display shelves, commonly referred to as “gondolas,” with multiple shelves that hold the available inventory of a multitude of products. Shoppers remove a product that they wish to purchase from the shelf and place it in a shopping cart that they are pushing through the store. The shopper takes their cart to a cashier who removes each item from the cart, identifies the item by scanning a barcode or manual entry into a purchasing system, collects payment from the customer, and places the purchased items in a bag for the customer to take with them.

### SUMMARY

In certain embodiments, it is desirable to provide a display system that enables replenishment of the on-hand stock on the shelf from the rear, enabling “first in, first out” stock rotation and avoiding the financial impact of stock that expires. In certain embodiments, the gondolas are selectably movable and back-to-back units can separate to provide access to the rear of the shelves.

In certain embodiments, it is desirable to provide a display system that automatically “fronts” a product, i.e. moves available stock to the front of a shelf, to increase the visibility of the product to a customer. In certain embodiments that include a “pusher” that moves product toward the front of the shelf, it is desirable that the pusher incorporates one or more of a display that may have a picture of the product, an indication that the product is out-of-stock, and a means for the customer to order one of the product, for example to be delivered to their home.

In certain embodiments, it is desirable to provide a single example product with an adjacent “purchase” button that signals a robotic system in the store stockroom to place one of the product in tote, wherein all purchases are accumulated in the tote and presented to the customer at the cashier's station for review and purchase. In certain embodiments, a running total of purchases and/or cost is provided to the customer on a display mounted on a shopping cart or a rolling stand or to the customer's mobile device. Alternately, the customer may choose to have a portion of the order delivered to their home.

In certain embodiments, it is desirable to provide a display wall that shows photo-realistic images of the products, wherein the display is covered by a touchscreen and the customer may order one of the products by touching the image or a soft button proximate to the image.

In certain embodiments, a conventional shelf may have a display unit positioned on the front edge that displays one or more of the product name, size, price, and unit price as well as other information, e.g. an indication that the item is on sale. The display unit may include a visual indicator, e.g. a multi-color LED or the background of a full-color display screen, that can be adjusted by the retailer to display a certain color indicating a status of the item. For example, the unit price of all similar units may be given a color with the least expensive being green and the most expensive being purple and intermediate unit prices being blue, turquoise, or other intermediate colors of the spectrum.

In certain embodiments, the store system can detect the position of the shopper with respect to the elves and cause the display unit to change state to reflect the preferences of that particular customer. For example, the display unit may flash to indicate the item purchased previously by the customer.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 depicts a conventional display gondola.

FIG. 2 depicts a conventional store aisle with two rows of back-to-back gondolas each having an endcap as well as display shelves on the store wall.

FIGS. 3-4 depict conventional inclined shelfs wherein product in each lane moves to toward the front under the influence of gravity.

FIG. 5 depicts an exemplary pair of gondolas configured to move apart, according to certain aspects of the present disclosure.

FIGS. 6A-6B depict an exemplary mobility system that selectively enables the gondolas to easily move apart, according to certain aspects of the present disclosure.

FIG. 7 depicts an example conventional store layout.

FIGS. 8A-8B depict an exemplary gondola system that selectively enables the gondolas to easily move apart, according to certain aspects of the present disclosure.

FIGS. 9A-9B depict conventional paper and e-paper shelf labels.

FIG. 10 depicts an exemplary shelf label that displays a color associated with a comparative attribute across similar adjacent products, according to certain aspects of the present disclosure.

FIG. 11 depicts an exemplary gondola system that displays a single example of each product, according to certain aspects of the present disclosure.

FIG. 12A depicts an exemplary gondola system that displays images and information for each product, according to certain aspects of the present disclosure.

FIG. 12B depicts an exemplary module of the gondola system of FIG. 12A, according to certain aspects of the present disclosure.

FIG. 12C depicts an exemplary block diagram of a purchasing system, according to certain aspects of the present disclosure.

FIG. 13 depicts an exemplary customer information interface mounted on a shopping cart, according to certain aspects of the present disclosure.

FIG. 14 depicts an exemplary customer information interface mounted on a dedicated workstation, according to certain aspects of the present disclosure.

FIG. 15 depicts an exemplary customer information interface provided on a mobile device, according to certain aspects of the present disclosure.

FIGS. 16A-16B depict conventional methods of displaying canned soup.

FIG. 16C depicts the ideal “fronted” shelf of the product of FIGS. 16A-16B.

FIG. 17 depicts an exemplary product pusher that includes a display that enables a customer to order a product that is out-of-stock, according to certain aspects of the present disclosure.

### DETAILED DESCRIPTION

The following description discloses embodiments of a disinfection apparatus.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form to avoid obscuring the concepts of the subject technology. Like, or substantially similar, components are labeled with identical element numbers for ease of understanding.

As used within this disclosure, the term “stationary” means that fixed elements of a gondola, such as rigid feet or a support beam, of a gondola are in direct contact with a fixed surface, such as the floor of a store, wherein the amount of force required to move the gondola is greater than can be provided by a normal person or a conventional motorized mechanism having a power output on the order of one horsepower.

As used within this disclosure, the term “movable” means that the gondola can be moved over a fixed surface by application of force that is within the ability of a normal person or within the design capability of a conventional motorized mechanism having a power output consistent with available electrical power. Movable gondolas may be supported by mobility devices, such as wheels, roller, and air casters, that are designed to facilitate horizontal motion while supporting a vertical load. A stationary gondola may be made movable by separating the fixed element of the gondola from the fixed surface, for example by activating a set of air casters to raise the gondola and support the gondola on a thin cushion of air that eliminates frictional contact between the fixed element and the floor.

In an embodiment, an item may be “stationary” when attached to a moveable structure, e.g. a panel hinged to a wall, having a mechanism, e.g. a latch, that is configured to retain the structure in a first position, i.e. “stationary,” then selectably allow the structure to move from the first position, i.e. “movable.”

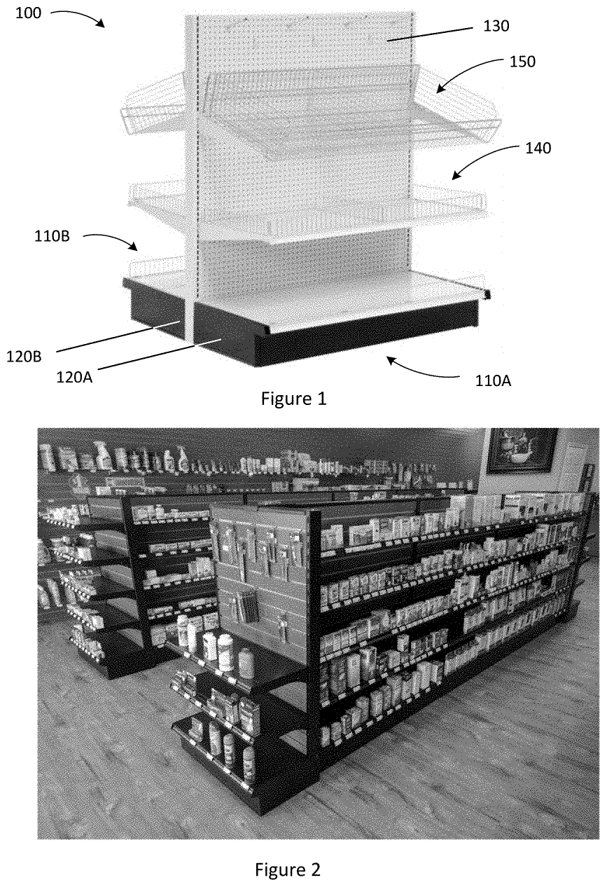

FIG. 1 depicts a conventional display gondola system 100. In this example, there is a first module 110A and a second module 110B, placed back-to-back. The module 110A has a base 120A and a support structure 130. A flat shelf 140 is attached to the support structure 130. A second inclined shelf 150 is also coupled to the support structure 130 and disposed at an angle such that its support surface slopes from the back to the front.

Conventional display gondola modules have fixed support elements that bear directly on the floor, making the gondola modules stationary. This is especially true when the shelves are loaded with products. The conventional retail gondolas require a significant amount of continual manual labor to maintain the displayed product in the optimal position and to continually rotate the stock to avoid product expiring before it is sold.

Access to the shelves is available only from the front. To add stock behind the existing stock, the existing stock must either be removed from the shelf or temporarily repositioned to provide a clear space from the front to the back of the shelf at each location, thereby allowing the new stock to be added at the back. The existing stock must then be repositioned back at the front of the shelf. This is time-consuming and risky, as either existing or new stock may be dropped or damaged while handling it.

It is common practice to “front” products, i.e. to have the available product positioned along the front edge of each shelf. Ideally, the additional stock is immediately behind the front items to avoid the customer having to reach toward the back to obtain a product. Fronting must be repetitively performed during the day with conventional shelves, as every purchase by a customer leaves a gap along the edge of the shelf. It requires significant staff time to check and reposition stock at regular time intervals to maintain conventional shelves with all products fronted.

FIG. 2 depicts a conventional store aisle with two rows of back-to-back gondolas each having an endcap as well as display shelves on the store wall.

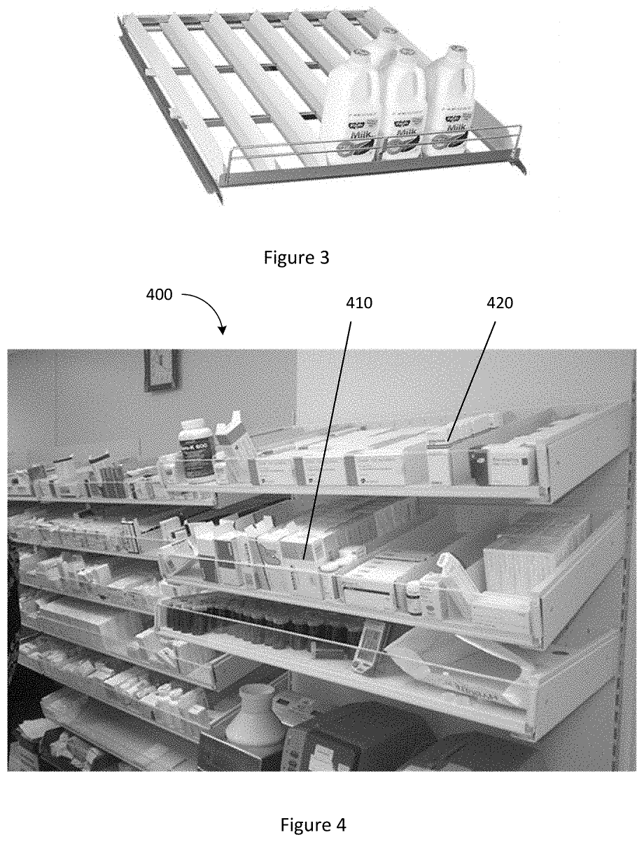

FIG. 3 depicts a conventional inclined shelf for containers of milk as found in refrigerated compartments within a grocery store. The shelf is inclined such that the bottles move toward the front under the influence of gravity. The dividers restrict the motion to a back-to-front direction.

FIG. 4 depicts a conventional shelf for a pharmacy, wherein boxed products and bottles are placed in inclined lanes defined by dividers.

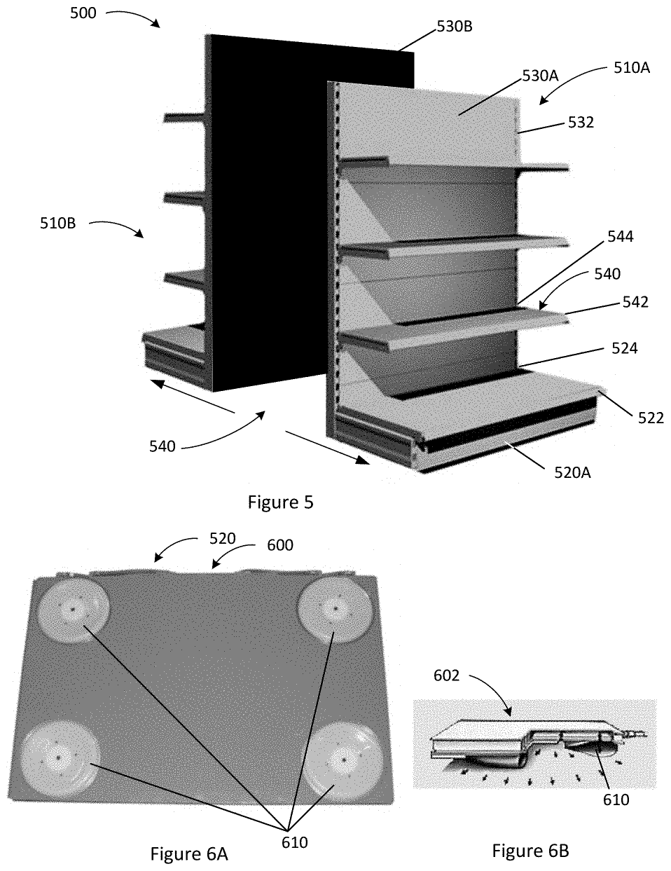

FIG. 5 depicts an exemplary gondola system 500 comprising a pair of gondolas 510A, 510B configured to move apart, according to certain aspects of the present disclosure. The module 510A has a base 520A with a front edge 522 and a rear edge 524. There is a support structure 530A with vertical rails 532 at each side. A shelf 540 has a front edge 542 and a rear edge 544. The shelf 540 is attached to the support structure 530 with the rear edge 544 proximate to the support structure 530.

When each of gondolas 510A, 510B are in their respective first positions, the rear surface of support 530B is generally proximate to the rear surface of support 503A. In this configuration, there is no rear access to the shelves 540. When the gondolas 510A, 510B are in their respective second positions, as shown in FIG. 5, a separation space 540 is created between the support 530B and the support 503A. This access space 540 provides rear access to the shelf 540 such that product can be added behind existing stock of product, which facilitates sale of the older stock.

FIGS. 6A-6B depict a base 520 having an exemplary mobility system 600 that selectively enables the gondolas 510A, 510B to easily move apart as shown in FIG. 5, according to certain aspects of the present disclosure. In this embodiment, the mobility system 600 comprises four air casters 610 disposed at corners of the base 520. The air casters 610 are interconnected by tubes (not visible in FIG. 6A) that supply pressurized air from an external source (not shown in FIG. 6A). FIG. 6B is a cutaway of an exemplary air caster 610 showing its construction as an inflatable toroidal bladder.

When in a first depressurized state, the toroidal bladder is collapsed and the base 520 descends until its structure, for example feet in each corner (not shown in FIG. 6A) touch the ground and support the weight of the gondola 520 and product disposed thereon. When in a second pressurized state, the air bladders inflate and raise structure so that the load is carried by the air caster, whereupon the gondola can be moved as shown in FIG. 5.

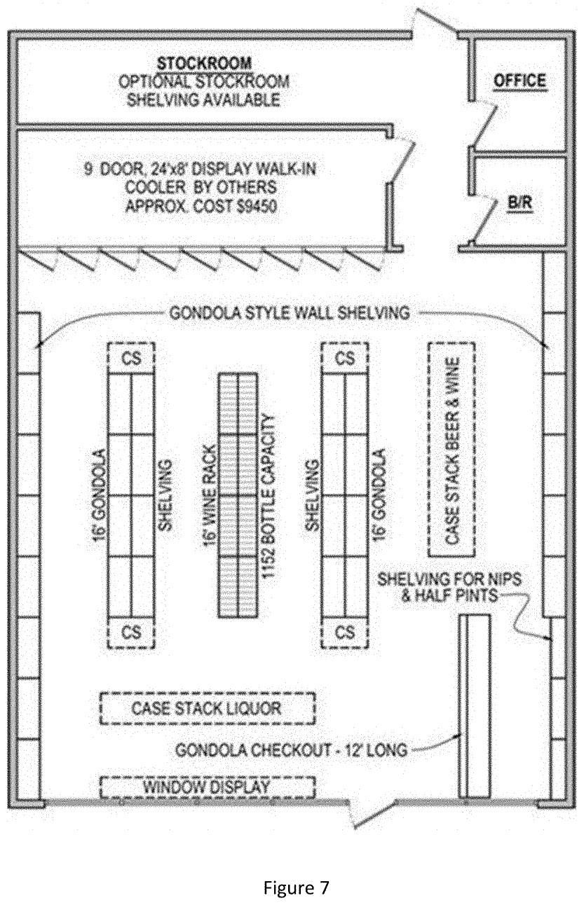

FIG. 7 depicts an example conventional store layout. Three rows of back-to-back gondolas are shown.

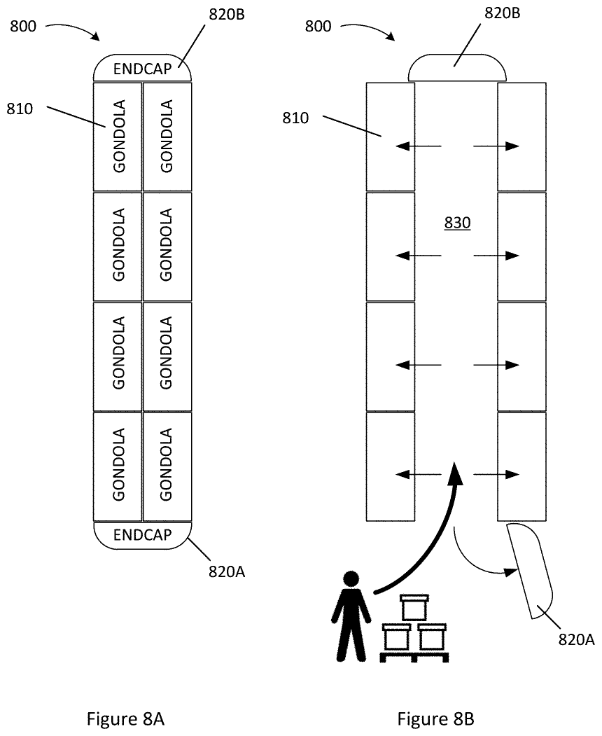

FIGS. 8A-8B depict an exemplary gondola system 800 that selectively enables the gondolas 810 to easily move apart, according to certain aspects of the present disclosure. FIG. 8A depicts the gondola system 800 with all gondolas in their first positions, which is the normal position for use by customers. Products are accessible from the front of the shelves.

FIG. 8B depicts the same system 800 with the gondolas in their respective second positions. Gondolas 810 have moved outward to create access space 830, which provides rear access to each of the shelves of the plurality of gondolas 810 and to the rear of endcap 820B. Endcap 820A has rotated to provide an opening into access space 830 as well as provide rear access to its shelves. An employee or other worker can enter space 830 with replenishment stock to add new product behind the existing stock.

Replenishing stock from the back facilitates stock rotation, which mitigates product loss due to expiration of the product before it is purchased. It is the practice used in hospitality and retail, especially in food stores such as supermarkets, of moving products with an earlier sell-by date to the front of a shelf, so they get picked up and purchased first, and of moving products with a later sell-by date to the back. The conventional practice for rotating stock is to remove the existing stock from the shelf, add the new stock at the back of the shelf, and then replace the pre-existing stock in front of the new stock. The conventional approach is time intensive and often avoided by workers as it is difficult to detect. The conventional approach also requires that the stock be handled multiple times, including being existing stock picked up from the shelf and placed on a cart or the floor. Each time a product is handled, there is a risk of being dropped or otherwise damaged.

Replenishing stock from the back facilitates “fronting” the shelves. Conventional shelves, wherein the staff have access only from the front, requires the staff to reach back over or around the existing stock to pull stock forward. This requires either an increased amount of vertical separation between shelves, so that there is sufficient room for a person's arm without hitting the stock, or limits the ability of staff to fronting only a single row of product. In either case, the product is no longer completely fronted as soon as a single customer removes a product from the shelf. Stores often employ staff whose job includes continuously moving along the shelves to front the product.

A limited number of grocery products are currently presented to customers on self-fronting shelving such as shown in FIG. 3. These shelves are conventionally provided only when adjacent to a refrigerated storeroom along a wall of the store, enabling staff to add stock to the shelves from the stockroom. This is not suitable for the free-standing fixed gondolas along the aisles, wherein gondolas are positioned back-to-back, as it causes the loss of 50% of the customer-facing display area.

Certain environments are particularly sensitive to expiration of products. The environments accept the increased cost and staffing that it takes to fully execute stock rotation. The included shelves of FIG. 4 are an example of a pharmacy system 400 that must ensure, by law and liability, that they do not dispense expired product. There are multiple challenges in this system.

Replenishment of product 410, which is tall compared to the separation of the shelves, will be difficult as the item must be turned and twisted to place a new box at the back of the shelf. The staff member must reach back and up and over the existing stock to place an item at the very back of the shelf. This is awkward, at best, and may poses hazard to the staff member.

Replenishment of product 420 requires a staff member to reach not only to the top shelf but to the very back of that shelf. This limits the height of the top shelf. Short employees may require a step stool or ladder to replenish stock, which adds a hazard to the working environment.

A system that enables staff to replenish stock from the back of the shelf will reduce the risk of damage to product during restocking, reduce the cost of expiration of product before sale, increase the available display space by enabling a reduced separation of shelves, and increase sales, while reducing labor costs, by enabling the use of self-fronting systems so that products are always fronted.

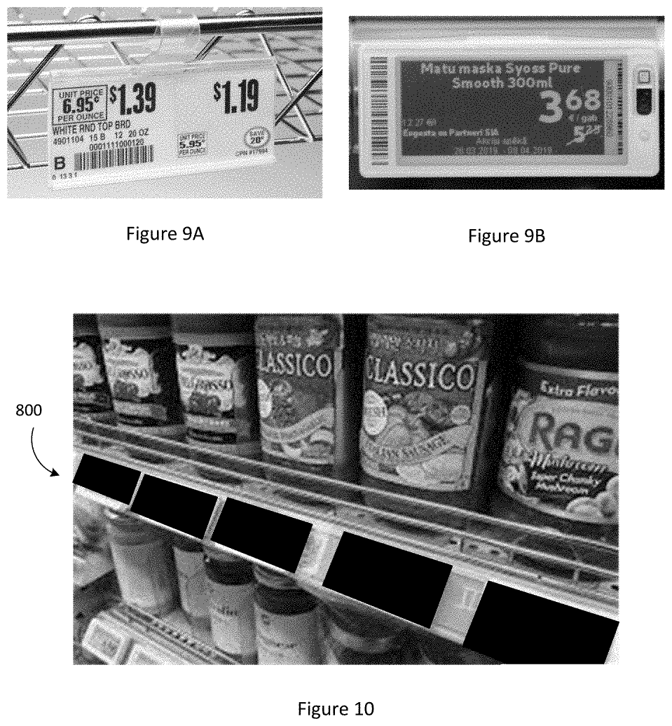

FIG. 9A depict a conventional paper shelf label. These must be reprinted and manually replaced each time a price changes or a product is added or dropped by the store. It is not uncommon for the prices on the labels to be different from the price charged at the check-out register in current stores, as the price changes in the database connected to the registers is not immediately reflected in the paper label.

FIG. 9B depicts a conventional e-paper label. This electronic device often includes a wireless communication link to the database so that changes in price or new products can be downloaded immediately. The e-paper technology of the display can provide three colors, typically white, black, and a single color (red in the example shown in FIG. 9B). E-paper is used because it does not require continuous power to retain the displayed information, so the battery life is extended compared to a LCD or other electronic display. This is an improvement over a paper label, but is still limited to a single accent color and therefore does not enable differentiation between similar products.

FIG. 10 depicts an exemplary shelf labeling system 800 that displays a color associated with a comparative attribute across similar adjacent products, according to certain aspects of the present disclosure. In this embodiment, the system 800 comprises a plurality of modules 810, with a module associated with the proximate product. Each of the modules 810 may displace a different color, with the number of colors limited only by the display technology. In practice, the number and selection of colors will be determined by the range of values being presented and the ability of the human eye to easily differentiate shades of color. In certain embodiments, a single long display (not shown in FIG. 10) may extend proximate to multiple products and segments of the long display can be associated with different products.

FIG. 10 depicts an exemplary shelf label that displays a color associated with a comparative attribute across similar adjacent products, according to certain aspects of the present disclosure.

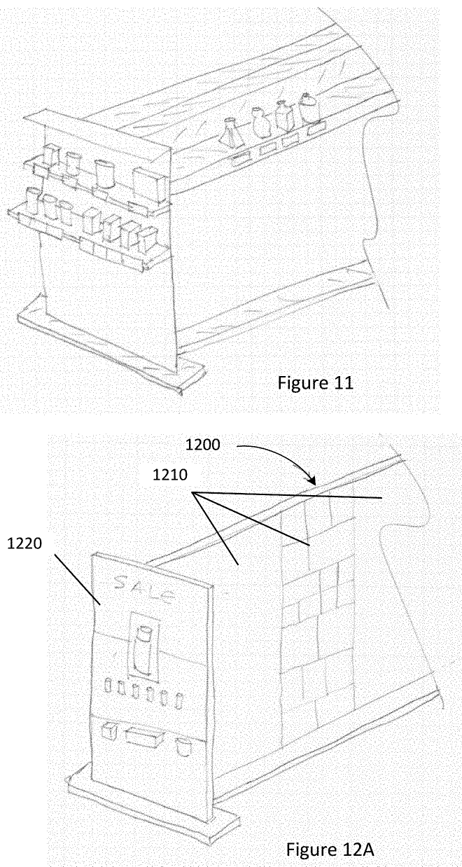

FIG. 11 depicts an exemplary gondola system that displays a single example of each product, according to certain aspects of the present disclosure. The shopper touches a button to indicate that they wish to purchase an item. In various embodiments, the shopper touches one of the image of the product displayed on the gondola, a button on the gondola, a soft or hard button on a shopping cart, or on a handheld mobile device, for example a phone or tablet.

In certain embodiments, for example a clothing store, a product may be displayed with physical samples of each size available for the shopper to try on. Once the shopper selects a product of a particular size, the sample product is returned to the display and the purchase is fulfilled from a separate stockroom. In certain embodiments, the order is fulfilled by shipment of the purchased product in a manner similar to online shopping. In certain embodiments, the sample products are tagged with RFID or other devices that can be detected at the front of the store, for example at the door, if a shopper attempts to remove one from the store.

In certain embodiments, selected items are presented to the shopper at a checkout station where the price of the selected items has already been aggregated into a total price. In certain embodiments, an employee at the checkout station performs one or more service of verifying that all selected products are included in the products at the checkout station, inspecting the products, removing any products that the shopper indicates that they no longer wish to purchase, andother services that are routinely performed at checkout. In certain embodiments, the total price has already been charged to the customer, for example against a credit card, and the purchases are bagged and presented to the customer.

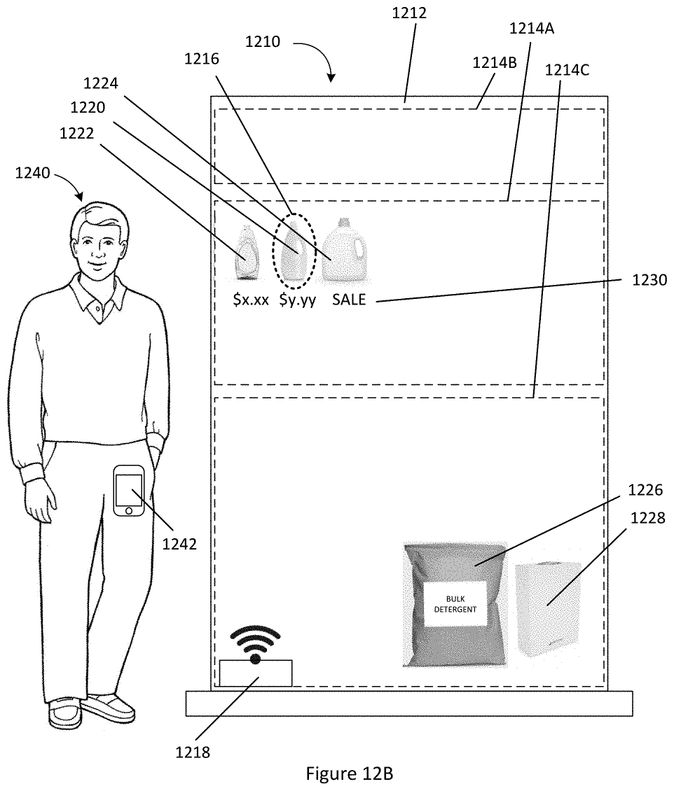

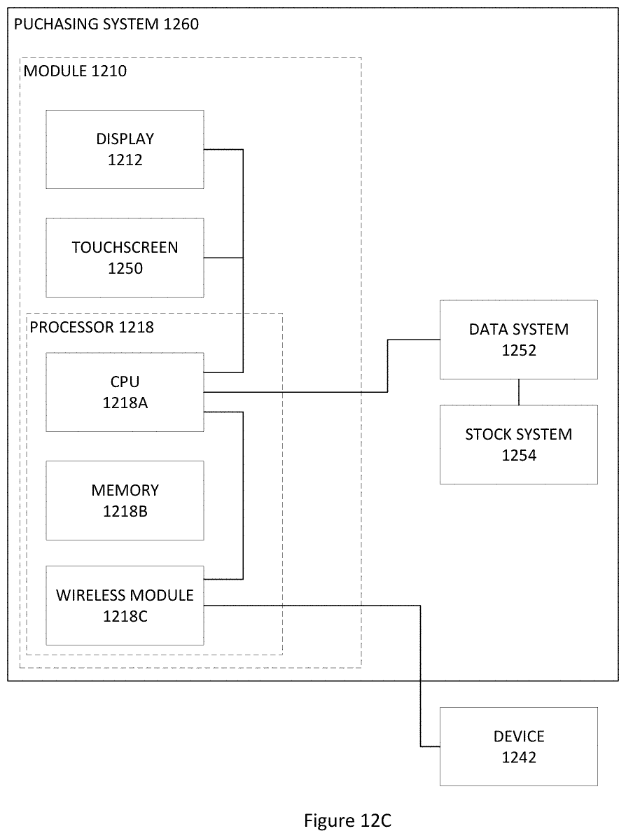

FIG. 12A depicts an exemplary gondola system that displays images and information for each product, according to certain aspects of the present disclosure. In certain embodiments, the placement of a product is changed based on the individual preferences and shopping habits of a particular shopper. For example, the selection of which products are presented at eye level can be modified for each shopper or based on collective current sales or on promotional strategies.

In certain embodiments, a stock of product is located in a separate stockroom. In certain embodiments, items selected by the shopper are retrieved from the stock and collected in a container that will be presented to the customer when they have finished shopping. In certain embodiments, the container is presented to a store agent who verifies the product is undamaged, bags the products, and removes items that the shopper decides that they no longer wish to purchase.

In certain embodiments, the stock is located in a remote location. The order is picked, packaged, and delivered in a manner consistent with online shopping.

In certain embodiments, the separate stock room enables fulfillment of online orders, thus combining the brick-and-mortar facility with online fulfillment. In certain embodiments, the separate stockroom enables collection and stocking of items to be done robotically and/or continuously.

In certain embodiments, a product is sanitized when retrieved from the stock shelf.

FIG. 12B depicts an exemplary module 1210 of the gondola system of FIG. 12A, according to certain aspects of the present disclosure. The module 1210 comprises a display 1212 facing the shopper 1240, wherein the entire area is a configurable display, e.g. a full-color LCD. In certain embodiments, portions of the display 1212 are covered by a motion-sensing system, e.g. a touchscreen. The display 1212 comprises a “preferred” display area 1214A that is generally disposed at eye level, which is known to those of skill in the art to be the preferred display area for products in a retail environment. In addition, there are secondary areas 1214B and 1214C that are proximate to the preferred area 1214A.

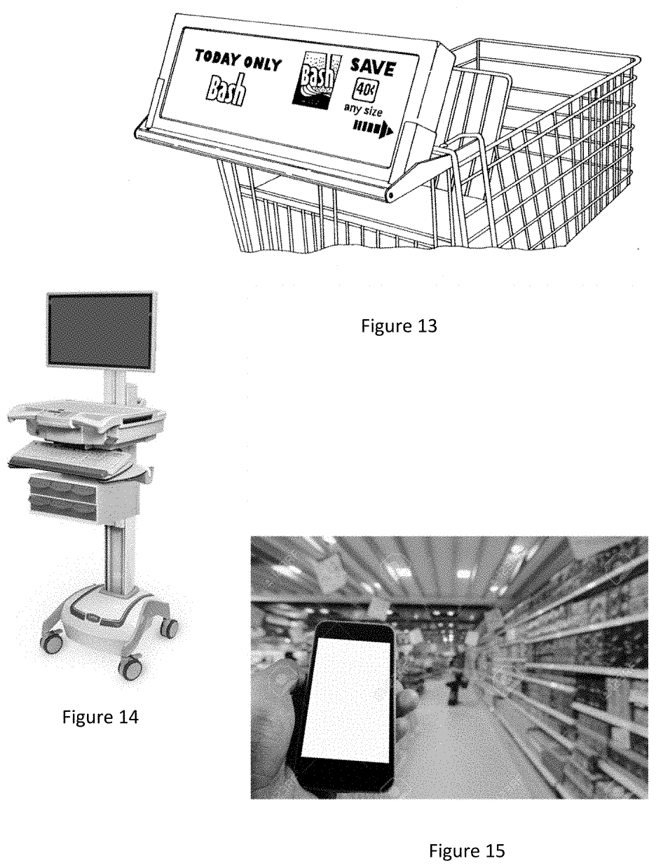

In certain embodiments, the module 1210 comprises a processor 1218 (normally hidden from view within the module 1210 and visible in FIG. 12B for clarity) that is functionally connected to the display 1212, the motion-sensing system, and to an external data system (not shown in FIG. 12B) that contains information about one or more of products, prices, promotions, and shopper identification, current purchase decisions, and purchase history. In certain embodiments, the processor 1218 comprises a wireless communication element, e.g. configured to emit and/or receive wifi or Bluetooth® signals or interact with a Radio Frequency Identification (RFID) tag, that is configured to detect a proximate device 1242, e.g. a mobile phone, carried by the shopper 1240. In certain embodiments, the device 1242 is a portable system provided by the store, for example the devices of FIG. 13 or FIG. 14, wherein the shopper has identified themselves to the device.

In certain embodiments, the processor 1218 determines which product images to display in which areas 1214A, 1214B, 1214C based on one of more of configuration settings of the store, e.g. which products are to be displayed on module 1210, product data retrieved from the data system, and shopper information. In certain embodiments, the processor 1218 determination is partially based on proximity of shopper 1240 to the module 1210. In certain embodiments, the product images displayed in preferred area 1214A are one or more of past purchases, products determined to be preferred by shopper 1240, for example by preferences provided by the shopper and/or past purchases. In certain embodiments, a previously purchased product 1220 will be highlighted by a visual artifact 1216, for example a dashed oval or a contrasting background color surrounding the image. In certain embodiments, an alternate product 1222 is displayed proximate to the product 1220. In certain embodiments, an alternate size/configuration 1224 of product 1220 is displayed in area 1214A. In certain embodiments, alternate products, for example a powdered product 1228 or a bulk package 1226, are displayed in areas 1214B or 1214C.

In certain embodiments, information 1230 about products 1220, 1222, 1224 is displayed proximate to the images of products 1220, 1222, 1224. In certain embodiments, this information is one or more of price, unit price, a product characteristic such as “organic,” and a promotional aspect such as “on sale” or a coupon.

Shopper 1240 indicates that he wishes to purchase a product, for example product 1220, by triggering the motion-sensing system proximate to the image of product. In certain embodiments, shopper 1240 indicates that he wishes to purchase a product by touching the touchscreen proximate to the image of product. The processor 1218 receives a signal from the touchscreen as to the location on the display where the shopper 1240 touched the screen, i.e. the “touchpoint,” associates that with the displayed images and determines which product image is proximate to the touchpoint, provide the product selection information to the data system, which then initiates a picking activity to retrieve this product from a storage area and add it to a “basket” of items to be provided to the shopper.

In certain embodiments, the data system may provide availability information to the processor 1218. If a selected product is not available in the store, the processor 1218 may display a notification message on the display 1212 informing the shopper 1240 that the item is not available. In certain embodiments, the notice includes one or more of an offer to ship the product, identification of alternate products, or a choice to cancel the selection.

In certain embodiments, the touchscreen is replaced by a hardware button and the image of the product is provided adjacent to the button.

FIG. 12C depicts an exemplary block diagram of a purchasing system 1260, according to certain aspects of the present disclosure. The purchasing system 1260 includes one or more of a display module 1210, a data system 1252, and a stock system 154. The processor 1218 comprises a computational processing unit (CPU) 1218A, a memory 1218B that comprises nonvolatile instructions that, when loaded into the CPU 1218A, cause the CPU to accomplish certain predetermined functions, and a wireless module 1218C that is configured to wirelessly communicate with device 1242. The CPU 1218A is communicatively coupled to a data system 1252 that comprises information about one or more of products, prices, promotions, shopper identification, current purchase decisions, and purchase history. The CPU 1218A is further communicatively coupled to a display 1212 and a touchscreen 1250 or equivalent.

In certain embodiments, the data system 1252 is communicatively coupled to a stock system 1254 that handles replenishment of product from suppliers.

FIGS. 13-15 depicts exemplary information systems that display real-time information about their purchases to customers, according to certain aspects of the present disclosure.

In certain embodiments, the software of the display is connected to internet stores, for example Amazon, and displays the prices of the same or equivalent product.

In certain embodiments, the software of the display retrieves information from the store database and displays a list or other comparative display of the product pricing, unit pricing, customer reviews, or sales.

In certain embodiments, the software of the display retrieves information from the store about previous purchased by the current shopper. This may include a shopping list of regular purchases, suggested alternate products based on current pricing, or other recommendations for the shopper.

In certain embodiments, the display retrieves information from the store about the items selected for purchase during the current visit. It may display a running total price, indicate items that are out of stock and will be shipped later, and allow entry of a budget by the shopper and display a running amount of the remaining budget.

FIGS. 16A-16B depict conventional methods of displaying canned soup. This dispenser structure of FIG. 16A is limited to cans, where the round profile enables the product to roll toward the back in the top portion and then drop to the lower track and roll toward the front. One drawback is that the product is presented sideways, as shown in FIG. 16B, and is as likely to be backwards as forwards, limiting the visibility of the package branding.

FIG. 16C depicts the ideal “fronted” shelf of the same product. The product is upright, so that the words are easily readable, and the front of the package is facing outward, displaying the brand image to the shopper.

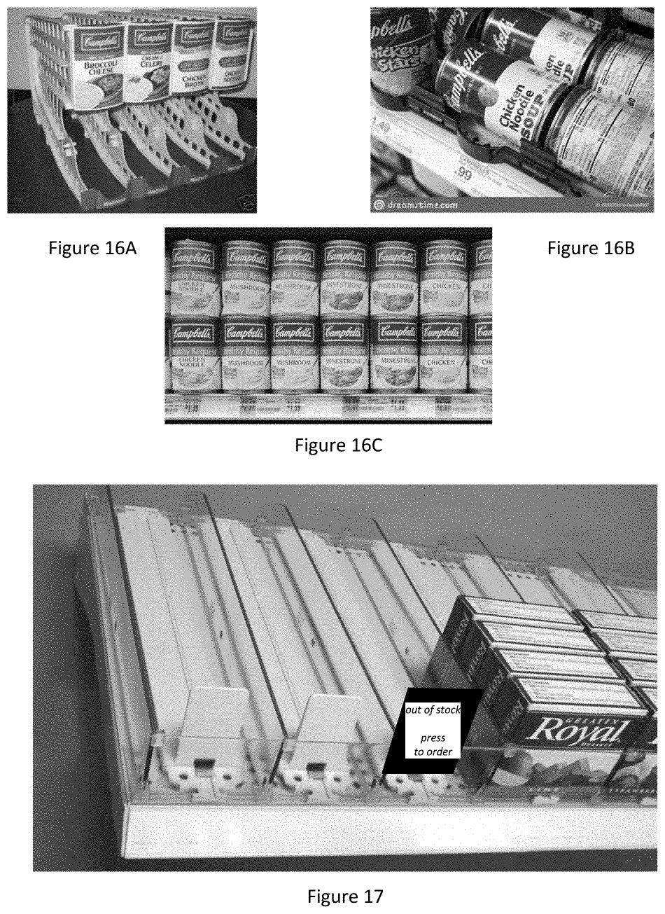

FIG. 17 depicts an exemplary product pusher that includes a display that enables a customer to order a product that is out-of-stock, according to certain aspects of the present disclosure. Additionally, it fronts the product in the preferred orientation.

### ASPECTS

Aspect 1. A shelving system for replenishing a stock of a product, comprising: a base; a support structure coupled to the base; and a shelf coupled to the support structure, the shelf having a front and a back; wherein: the system has a first configuration that provides access to the front of the shelf but not to the back of the shelf; and the system has a second configuration that provides access to the back of the shelf so as to enable replenishment of the stock by adding additional product from the back of the shelf.

Aspect 2. The shelving system of aspect 1, wherein: the base has a first position in the first configuration and a second position in the second configuration; and the second position is displaced from the first position.

Aspect 3. The shelving system of aspect 2, further comprising: a mobility system fixedly coupled to the base, the mobility system having a first state in which the base is stationary and a second state in which the base is movable; wherein activation of the mobility system enables the base to be moved from the first position to the second position.

Aspect 4. The shelving system of aspect 3, wherein the mobility system comprises an air caster.

Aspect 5. A method of replenishing a stock of a product on a gondola disposed on a surface, comprising the steps of: changing a mobility system from a first state to a second state, wherein: the mobility system is coupled to an underside of the gondola, the gondola is in direct contact with the surface in the first state, the gondola is supported above the surface by the mobility system in the second state, and the gondola is movable over the surface while in the second state; and moving the gondola from a first position in which a back of the gondola is not accessible to a second position that provides access to the back of the gondola; adding stock to the gondola through the back of the gondola.

Aspect 6. The method of aspect 5, wherein the step of moving the gondola is performed while the mobility system is in the second state.

Aspect 7. The method of aspect 5, wherein the step of adding stock is preceded by a step of changing the mobility system from the second state to the first state.

Aspect 8. The method of aspect 5, wherein: the gondola is stationary when the gondola is in direct contact with the floor; and the gondola is movable when the gondola is supported above the floor.

Aspect 9. A retail sales system, comprising: a gondola comprising: a display; and a touchscreen overlaid on the display and configured to provide a first signal when the touchscreen is touched, the first signal comprising a position where the touchscreen was touched; and a processor coupled to the display and the touchscreen, the processor configured to: cause the display to provide an image of a product; receive the first signal from the touchscreen; determine if the position corresponds to the image; and record a purchase request for the product when the position corresponds to the image.

Aspect 10. The retail sales system of aspect 9, further comprising a plurality of gondolas disposed in a row with the displays aligned to form a display wall, wherein the processor is coupled to each of the displays and touchscreens of the plurality of gondolas.

Aspect 11. The retail sales system of aspect 9, further comprising a wireless module coupled to the processor and configured to determine a location of a device carried by a customer and provide a second signal comprising the location, wherein the processor is further configured to receive the second signal and associate the purchase request with the device when the device is proximate to the image of the product.

Aspect 12. The retail sales system of aspect 11, wherein the processor is further configured to modify a position on the display where the image of the product is provided based on the proximity of the device to the display.

Aspect 13. The retail sales system of aspect 11, wherein the processor is further configured to modify which images of products are provided on the display based on the proximity of the device to the display.

Aspect 14. The retail sales system of aspect 11, wherein the processor is further configured to provide information comprising the purchase request to the device.

Aspect 15. The retail sales system of aspect 9, wherein the display has a height that is greater than 40 inches.

Aspect 16. The retail sales system of aspect 9, wherein the processor is further configured to cause the display to provide information associated with the product.

Aspect 17. The retail sales system of aspect 9, wherein the processor is further configured to provide the purchase request to an inventory management system configured to order a replacement of the product.

Headings and subheadings, if any, are used for convenience only and do not limit the invention.

Reference to an element in the singular is not intended to mean “one and only one” unless specifically so stated, but rather “one or more.” Use of the articles “a” and “an” is to be interpreted as equivalent to the phrase “at least one.” Unless specifically stated otherwise, the terms “a set” and “some” refer to one or more.

Terms such as “top,” “bottom,” “upper,” “lower,” “left,” “right,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Although the relationships among various components are described herein and/or are illustrated as being orthogonal or perpendicular, those components can be arranged in other configurations in some embodiments. For example, the angles formed between the referenced components can be greater or less than 90 degrees in some embodiments.

Although various components are illustrated as being flat and/or straight, those components can have other configurations, such as curved or tapered for example, in some embodiments.

Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “operation for.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such as an embodiment may refer to one or more embodiments and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

Although embodiments of the present disclosure have been described and illustrated in detail, it is to be clearly understood that the same is by way of illustration and example only and is not to be taken by way of limitation, the scope of the present invention being limited only by the terms of the appended claims.

What is claimed is:

1. A shelving system for replenishing a stock of a product, comprising:
a base;
a support structure coupled to the base; and
a shelf coupled to the support structure, the shelf having a front and a back;
wherein:
the system has a first configuration that provides access to the front of the shelf but not to the back of the shelf; and
the system has a second configuration that provides access to the back of the shelf so as to enable replenishment of the stock by adding additional product from the back of the shelf.

2. The shelving system of claim 1, wherein:
the base has a first position in the first configuration and a second position in the second configuration; and
the second position is displaced from the first position.

3. The shelving system of claim 2, further comprising:
a mobility system fixedly coupled to the base, the mobility system having a first state in which the base is stationary and a second state in which the base is movable;
wherein the base can be moved between the first position and the second position when the mobility system is in the second state.

4. The shelving system of claim 3, wherein the mobility system comprises an air caster.

5. A method of replenishing a stock of a product on a gondola disposed on a surface, comprising the steps of:
changing a mobility system from a first state to a second state, wherein:
the mobility system is coupled to an underside of the gondola,
the gondola is in direct contact with the surface in the first state,
the gondola is supported above the surface by the mobility system in the second state, and
the gondola is movable over the surface while in the second state; and
moving the gondola from a first position in which a back of the gondola is not accessible to a second position that provides access to the back of the gondola;
adding stock to the gondola through the back of the gondola.

6. The method of claim 5, wherein the step of moving the gondola is performed while the mobility system is in the second state.

7. The method of claim 5, wherein the step of adding stock is preceded by a step of changing the mobility system from the second state to the first state.

8. The method of claim 5, wherein:
the gondola is stationary when the gondola is in direct contact with the floor; and
the gondola is movable when the gondola is supported above the floor.

9. A retail sales system, comprising:
a gondola comprising:
a display; and
a touchscreen overlaid on the display and configured to provide a first signal when the touchscreen is touched, the first signal comprising a position where the touchscreen was touched; and
a processor coupled to the display and the touchscreen, the processor configured to:
cause the display to provide an image of a product;
receive the first signal from the touchscreen;
determine if the position corresponds to the image; and
record a purchase request for the product when the position corresponds to the image.

10. The retail sales system of claim 9, further comprising a plurality of gondolas disposed in a row with the displays aligned to form a display wall, wherein the processor is coupled to each of the displays and touchscreens of the plurality of gondolas.

11. The retail sales system of claim 9, further comprising a wireless module coupled to the processor and configured to determine a location of a device carried by a customer and provide a second signal comprising the location, wherein the processor is further configured to receive the second signal and associate the purchase request with the device when the device is proximate to the image of the product.

12. The retail sales system of claim 11, wherein the processor is further configured to modify a position on the display where the image of the product is provided based on the proximity of the device to the display.

13. The retail sales system of claim 11, wherein the processor is further configured to modify which images of products are provided on the display based on the proximity of the device to the display.

14. The retail sales system of claim 11, wherein the processor is further configured to provide information comprising the purchase request to the device.

15. The retail sales system of claim 9, wherein the display has a height that is greater than 40 inches.

16. The retail sales system of claim 9, wherein the processor is further configured to cause the display to provide information associated with the product.

17. The retail sales system of claim 9, wherein the processor is further configured to provide the purchase request to an inventory management system configured to order a replacement of the product.
